(19) United States
(12) Patent Application Publication
(10) Pub. No.: US 2010/0319505 A1
(43) Pub. Date: Dec. 23, 2010

(54) DEVICE AND METHOD FOR CONVEYING A PAPER WEB

(76) Inventors: Ronald Celeste, Kuehlenthal (DE); Bernd Hoepner, Augsburg (DE)

Correspondence Address: The Brill Law Office, 2900 Gordon Avenue, Suite 100-38, Santa Clara, CA, 95051, US

(21) Appl. No.: 12/676,347

(22) PCT Filed: Sep. 2, 2008
(86) PCT No.: PCT/EP08/07166

§ 371 Date: Sep. 8, 2010

(30) Foreign Application Priority Data
Sep. 3, 2007 (DE) 102007041811.8

(51) Int. Cl. B26D 9/00; B26D 1/157; B26D 7/01; B26D 1/08

(52) U.S. Cl. 83/39; 83/408; 83/418; 83/436.7

(57) ABSTRACT

In a device and a method for conveying a paper web, there is provided a longitudinal cutter to cut a paper web conveyed in a conveying direction into at least a first partial web and a second partial web. Furthermore, there is provided a support member arranged behind the longitudinal cutter in conveying direction and supporting at least a portion of the first partial web and at least a portion of the second partial web so that movement of the first partial web and the second partial web in a direction transverse to the conveying direction is substantially blocked and that movement of the first partial web and the second partial web in the conveying direction is substantially not hindered.

### BACKGROUND OF THE INVENTION

Embodiments of the invention relate to a device and to a method for conveying a paper web, particularly to a device and a method allowing for stabilizing the advance of partial webs obtained by longitudinally cutting the paper web. Further embodiments of the invention relate to devices and methods that cut the partial webs into individual sheets, wherein the partial webs were obtained by longitudinally cutting the paper web, wherein the partial webs are stabilized during conveying to the cross-cutter for a clean cross-cut. In particular, embodiments of the invention relate to cutters employed in paper handling systems.

Paper handling systems that receive individual products, for example personalized letters or sheets, combine the same into groups consisting of a plurality of individual products, and process the same further for dispatch are known in conventional technology. Such groups include a letter to a receiver, as well as maybe one or more following pages of the letter, as well as objects associated with the letter, for example credit cards or the like, for example. Furthermore, the group may include supplements. The compiled group is then prepared for dispatch, for example by folding the group and welding the edges of the folded group together, or by enveloping the collected groups.

Such a system receives the sheets to be processed via one or more input channels, wherein such an input channel may be formed such that a printed paper web originating from an upstream printer or a roll is supplied. Such paper webs may be printed in a multi-up manner, i.e., two or more prints are provided in parallel on a paper web. When supplying documents thus prepared, on the one hand, a longitudinal cut of the supplied paper web in the input channel, and, on the other hand, a cross-cut of the longitudinally cut partial webs may be performed so as to create individual sheets from the input documents provided in a multi-up manner. Usually, the documents are provided in a two-up manner, i.e., two prints are arranged next to each other in parallel with respect to each other on a paper web, so that two individual sheets are obtained by the subsequent longitudinal cut and cross-cut from each portion of the paper web that has been cut in two partial webs. Likewise, however, the documents may also be provided in a three-up or more-up manner in the input channel.

### SUMMARY

According to an embodiment, a device for cutting a paper web may have: a drive arranged to convey the uncut paper web in a start/stop operation in a conveying direction; a longitudinal cutter arranged behind the drive in conveying direction, in order to cut the paper web conveyed in conveying direction into at least a first partial web and a second partial web; a support member moveable in conveying direction and arranged behind the longitudinal cutter in conveying direction such that the support member builds up a supporting moment on the partial webs so that the partial webs neither rotate nor shift laterally, wherein the support member supports at least a portion of the first partial web and at least a portion of the second partial web, wherein the support member is formed to block movement of the first partial web and the second partial web in a direction transverse to the conveying direction and not to hinder movement of the first partial web and the second partial web in the conveying direction; and a cross-cutter arranged behind the support member in conveying direction so as to cut the partial webs into individual sheets during standstill thereof.

According to another embodiment, a paper handling system may have an input channel for receiving a paper web; a device for producing a parallel stream of individual sheets from the paper web and for cutting a paper web, wherein the device may have: a drive arranged to convey the uncut paper web in a start/stop operation in a conveying direction; a longitudinal cutter arranged behind the drive in conveying direction, in order to cut the paper web conveyed in conveying direction into at least a first partial web and a second partial web; a support member moveable in conveying direction and arranged behind the longitudinal cutter in conveying direction such that the support member builds up a supporting moment on the partial webs so that the partial webs neither rotate nor shift laterally, wherein the support member supports at least a portion of the first partial web and at least a portion of the second partial web, wherein the support member is formed to block movement of the first partial web and the second partial web in a direction transverse to the conveying direction and not to hinder movement of the first partial web and the second partial web in the conveying direction; and a cross-cutter arranged behind the support member in conveying direction so as to cut the partial webs into individual sheets during standstill thereof and a processing channel for processing the individual sheets.

According to another embodiment, a method of cutting a paper web, may have the steps of: driving the uncut paper web in a start/stop operation in a conveying direction; longitudinally cutting the paper web conveyed in conveying direction into at least a first partial web and a second partial web; supporting at least a portion of the first partial web and at least a portion of the second partial web by a support member moveable in conveying direction and arranged between a longitudinal cutter and a cross-cutter such that the support member builds up a supporting moment on the partial webs so that the partial webs neither rotate nor shift laterally, wherein movement of the first partial web and of the second partial web in a direction transverse to the conveying direction is blocked, and wherein movement of the first partial web and of the second partial web in the conveying direction is not hindered; and cross-cutting the partial webs into individual sheets during standstill thereof.

Embodiments of the invention provide a device and a method for conveying a paper web.

### BRIEF DESCRIPTION OF THE DRAWINGS

Embodiments of the present invention will be detailed subsequently referring to the appended drawings, in which:

FIG. 1 is a schematic illustration of a paper handling system in which cutters according to embodiments of the invention are employed;

FIGS. 2 (A) to (C) are a schematic top-view illustration of a known cutter with a tractor drive and/or a roller drive, as well as schematic side illustrations along lines B-B and C-C in FIG. 2(A);

FIG. 3 is the illustration of the cutter from FIG. 2, wherein the centers of mass and effective lever arms existing in the case of a tractor transport and/or in the case of an advance via rollers (roller transport) for the partial webs after longitudinally cutting are shown;

FIGS. 4A and (B) show the drift of the two partial webs when using a tractor advance and/or a roller transport in accelerating and decelerating;

FIGS. 5(A) and (B) show the errors, which occur because of the drift of the partial webs, along the outer longitudinal cutting edge when separating a tractor edge from the paper web;

FIG. 6 shows a possible, non-rectangular cutting edge after separating a partial web by a cross-cutter because of the drift;

FIGS. 7(A) and (B) are a schematic top-view illustration and a schematic side illustration, respectively, of a device for stabilizing the movement of the partial webs according to an embodiment of the invention, using a roller for support for each of the partial webs;

FIGS. 8(A) and (B) are schematic top-view illustrations of a device for stabilizing the movement of the partial webs according to a second embodiment of the invention, using a common roller for support for two partial webs;

FIGS. 9(A) to (L) show examples of configurations of the support elements that may be used in embodiments of the invention;

FIGS. 10(A) and (B) are a schematic top-view illustration and a schematic side illustration, respectively, of a cutter according to an embodiment of the invention, using two spaced-apart roller pairs for each partial web for supporting the two partial webs;

FIGS. 11(A) and (B) are a schematic top-view illustration and a schematic side illustration, respectively, of a cutter according to a further embodiment of the invention, using a parallel pair of belts, which act on the partial web from above, for each partial web for supporting the two partial webs; and

FIG. 12 is a schematic top-view illustration of a device for stabilizing the movement of cut partial webs according to a further embodiment of the invention, wherein a paper web is cut in four partial webs.

### DETAILED DESCRIPTION OF THE INVENTION

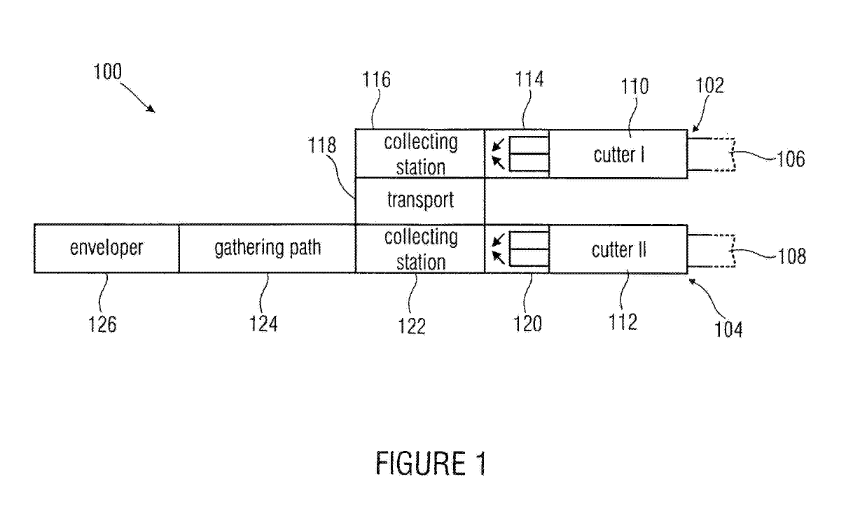

FIG. 1 shows a schematic illustration of a paper handling system in which embodiments of the invention, for example cutters according to embodiments of the invention, may be employed. Such a paper handling system includes a supply channel, which includes cutters and sheet placers, for example. The supply channel is followed by an input channel/processing channel, in which products are collected, folded and gathered. A gathering path provided on the input channel/processing channel includes one or more supplement placers, for example. The input channel/processing channel is followed by the envelope filling, wherein an enveloper here comprises an envelope placer, for example, providing the envelopes. The enveloper is followed by the post-processing, for example the output of the enveloped products to a post-processing system, e.g., a sorter or the like. For example, the system described in FIG. 1 is an enveloping system, as mainly used for banks and for insurance companies, for example for the dispatch of insurance documents endlessly printed in a one-up or two-up manner.

The enveloping system 100 shown in FIG. 1 includes a first input 102 and a second input 104 provided with an endless web 106 and 108 each, which is printed in a two-up manner. The inputs 102 and 104 include cutters 110 and 112, respectively, so as to both longitudinally cut and cross-cut the supplied paper web 106 and 108, so as to produce the individual sheets to be processed, as will still be explained in greater detail in the following on the basis of the embodiments of the invention.

The first input 102 is followed by a merger or merging path 114, which is followed by a collecting station 116 in which a predetermined number of products are collected and moved on further together as a group. The collecting station 116 is followed by a transport module 118. The second input 104 is followed by a merger or merging path 120, which is followed by a collecting station 122 in which a predetermined number of products are collected. The collecting station 122 receives remote products from the transport module 118. Starting from the collecting station 122, the collected products are provided to a gathering path 124 with placers capable of selectively adding further supplements to the product stacks. Finally, the products and/or groups of products are provided to an enveloper 126 enveloping the same in corresponding envelopes.

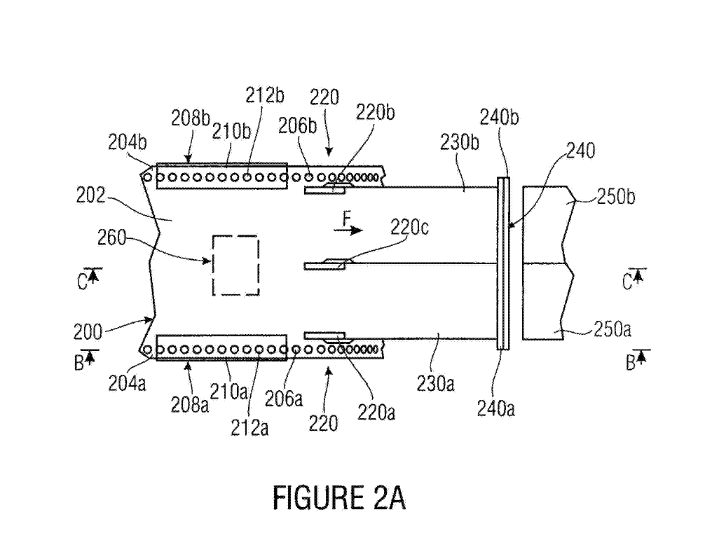

FIG. 2(A) shows a schematic top-view illustration of a known cutter, such as employed in the inputs 102 and 104 illustrated in FIG. 1, for example, so as to both longitudinally cut and cross-cut the paper webs 106 to 108 shown there. FIGS. 2(B) and (C) show schematic side illustrations along the line B-B and/or C-C in FIG. 2(A).

FIG. 2(A) shows the paper web 200, which includes a central area 202 as well as two edge areas 204a and 204b, in the embodiment illustrated. The edge areas 204a and 204b of the paper web 200 are perforated and include a plurality of holes 206a, 206b provided for engagement by corresponding pins 212a, 212b of a tractor drive, schematically labeled with the reference numeral 208a, 208b in FIG. 2(A). The tractor transport 208a, 208b includes a tractor belt 210a, 210b on which the multiplicity of pins 212a, 212b, which are provided for engagement with the holes 206a, 206b in the edge areas 204a, 204b of the paper web 200, are mounted (see FIG. 2(B)). The tractor belt is guided over two rollers 214 and 216, with at least one of said rollers being driven. The tractor transports 208a and/or 208b shown in FIG. 2(A) are jointly driven, for example via a common shaft, so as to cause an advance of the paper web 200 in conveying direction F.

Downstream of the tractor transports 208a and 208b, there is arranged a longitudinal cutter 220 including a first cutting element 220a, a second cutting element 220b, as well as a third cutting element 220c. Each of these cutting elements 220a to 220c is formed by a lower cutting roll 222 and an upper cutting roll 224 between which the paper web 200 passes, as can be seen in FIG. 2(B), wherein a cut of the paper web 200 in conveying direction F is effected by the cutting rollers 222 and 224. The first cutting element 220a of the longitudinal cutter 220 serves for separating the edge area 204a, and the second cutting element 220b first for separating the edge area 204b. Hereby, the edge area engaging with the tractor transport and still needed for the supply is removed for subsequent processing.

The third cutting element 220c is arranged centrally with respect to an expansion of the paper web 200 perpendicular to the conveying direction F in the example shown, particularly centrally in the central area 202 of the paper web. The cutting element 220c causes a longitudinal cut of the paper web 200 such that two paper webs 230a and 230b conveyed in parallel are produced from the one-piece paper web 200. The partial webs 230a and 230b are also moved further in conveying direction F due to the movement of the paper web 200. In the example shown, the movement is in the direction of a cross-cutter 240, which is formed as a guillotine cutter and includes a lower, stationary blade 240a and an upper, moveable blade 240b. The upper blade 240b is moveable vertically so as to effect a crosscut of the partial webs 230a and 230b in cooperation with the lower blade 240a, in order to separate the partial webs into individual sheets 250a and 250b.

Instead of the cutting rollers 222 and 224 described above, simple, e.g. static blades slitting the paper web may also be used for longitudinally cutting.

As an alternative to the tractor transport 208a and 208b, a roller transport 260 (drawn in dashed lines) may also be provided in the central area 202 of the paper web 200. As can be seen from FIG. 2(C), the roller transport includes a lower, idling roller 262 as well as an upper, driven roller 264, between which the paper web 200 is arranged at least in a middle region of the central area 202. Advance of the paper web 200 in conveying direction F takes place via the pair of rollers 262, 264.

At this point, it is to be pointed out that FIG. 2 shows an exemplary paper web 200, which nevertheless comprises the edge areas 204a and 204b with the holes 206a and 206b when using a roller transport 260 (without tractor transport) for the advance of the paper web 200 in conveying direction F. As described above, these edge areas are separated by the cutting element 220a and 220b of the longitudinal cutter 220. Alternatively, when using a roller transport 260, one may also use a paper web not comprising edge areas with holes. In this case, only the central cutter 220c of the longitudinal cutter would be needed. The outer cutters 220a, 220b may, however, be retained e.g., for format adaptation (cutting the outside edges to the appropriate format).

In the known cutting machine described above on the basis of FIG. 2, the paper 200 is conveyed either via a tractor belt (pin feed) 210a, 210b or via a roller pair (pin-less) 262, 264. The tractor belt 210 engages with the outer, perforated edges 204a and 204b of the paper web 200. The roller pair 262, 264 usually engages with the middle of the paper web 200. The arrangement of the elements in paper running direction or conveying direction F usually is as follows: advance drive by the tractor transport or the roller transport—longitudinal cutting blade(s)—cross-cutting blade(s). This arrangement is due to the fact that the paper edge 204a, 204b is still needed for the advance in the case of the tractor transport and then is cut off by the longitudinal blades 220a and 220b and discarded. When utilizing a roller pair 262, 264 for advancing (pin-less), it usually engages with the middle of the paper web 200 and does not extend across the entire width of the paper web 200. The reason for this lies in the different format widths (also narrow formats). Hereby, readjusting the rollers in the case of a format change can be avoided. Between the longitudinal cutting blades 220a to 220c and the cross-cutter 240, there may be rigid paper guiding elements (not shown in FIG. 2), such as metal sheets or guiding rods, however only having loose, frictional contact with the paper web, without any frictional grip existing.

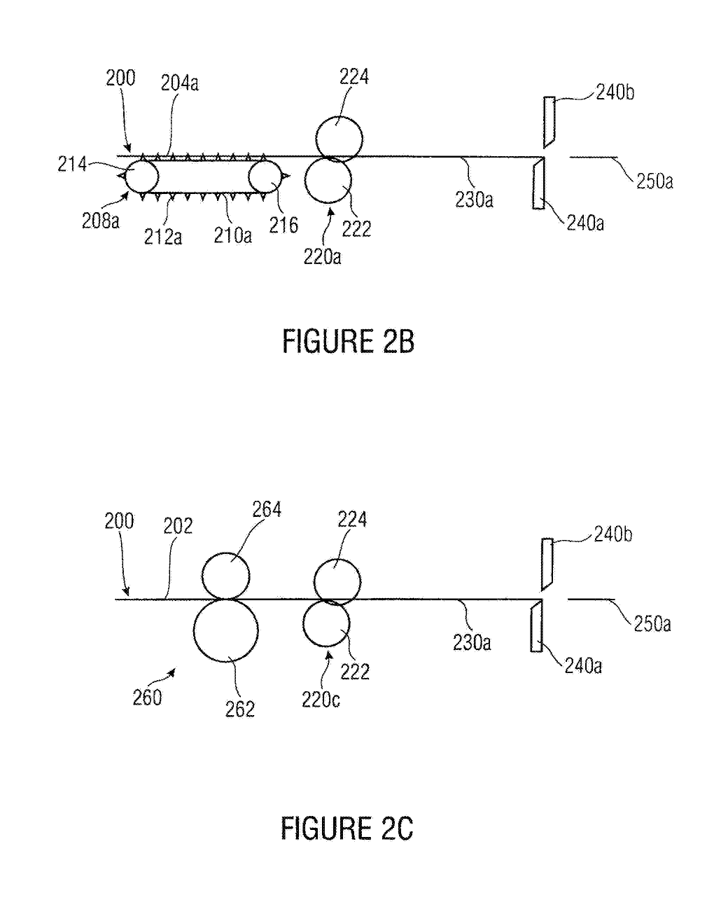

The known cutter described on the basis of FIG. 2 operates in a start-stop operation, i.e., the paper web 200 is accelerated from the rest state, advanced and decelerated again before the cut, and positioned below the cross-cutter 240. In the two-up operation, as has been described on the basis of FIG. 2, two strips or partial webs 230a and 230b are advanced in this way from the longitudinal cutter 220 onward. This means that there are two centers of mass from the longitudinal cutter 220 onward, each lying in the middle of a partial web 230a and 230b. FIG. 3 is the illustration of the cutter from FIG. 2(A), showing the centers of mass 270a and 270b just mentioned for each of the partial webs 230a and 230b. The centers of mass 270a and 270b shown in FIG. 3 each have a distance 272a and 272b respectively, in a direction transverse to the conveying direction F with respect to the advancing element, here the tractor transport 210a and 210b, whereby a lever arm results. The forces developing when accelerating also act on the centers of mass 270a and 270b behind the longitudinal cutter 220, the respective lever arms 272a and/or 272b generating a torque leading to an influence on the running direction of the individual partial webs 230a and 230b, so that straight movement of these partial webs is no longer the case when accelerating and/or decelerating. The roller transport and the lever arms 273a and 273b in effect in the case without tractor transport are shown in dashed lines in FIG. 3.

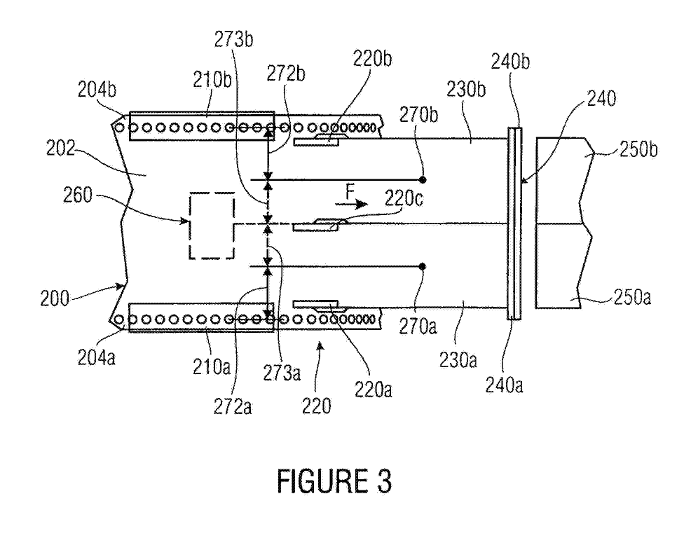

FIG. 4 shows the drift of the two partial webs when using a tractor transport in accelerating the partial webs and/or when using a roller transport in decelerating the partial webs (FIG. 4(A)) and when using a tractor transport in decelerating the partial webs and/or when using a roller transport in accelerating the partial webs (FIG. 4(B)). For the sake of simplicity, FIG. 4 only shows the elements from FIG. 3 that are needed for explaining the drift. When using a tractor transport, the strips of partial webs 230a, 230b have the tendency of moving on top of each other when accelerating and moving apart from each other when decelerating. FIG. 4(A) shows the drift of the partial webs 230a and 230b in the case of an acceleration of the paper web 200, using a tractor transport 210a, 210b. As can be seen, movement of the paper webs 230a and 230b here takes place transversely with respect to the conveying direction F, as this is shown by the arrows 274a and 274b, whereby the two partial webs 230a and 230b overlap, as this is shown by the overlapping area 276 in FIG. 4(A). When decelerating (see FIG. 4(B)) the paper web 200, there is a respective movement of the partial webs 230a and 230b, due to the centers of mass and the lever arms shown in FIG. 3, in a direction perpendicular to the conveying direction F, but in opposite directions, as indicated by the arrows 278a and 278b, so that the gap 280 develops between the two partial webs 230a and 230b.

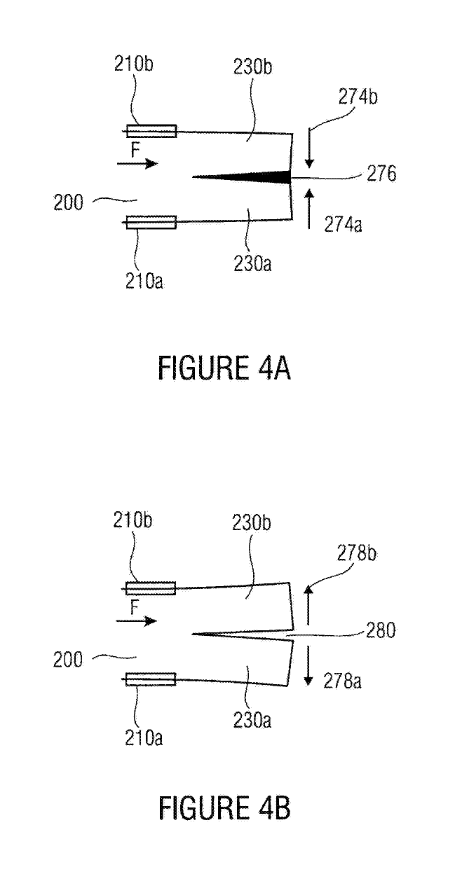

In contrast to when using a tractor transport, the partial webs 230a and 230b show the tendency of moving apart when accelerating and of moving on top of each other when decelerating, when a roller transport is used, due to the centrally arranged pair of rollers 260 and due to the forces acting now. When accelerating (see FIG. 4(B)), the partial webs 230a and 230b move apart, as this is shown by the arrows 278a and 278b, so that the gap 280 develops. When decelerating (see FIG. 4(A)), the partial webs move toward each other in a direction perpendicular to the conveying direction F, as this is shown by the arrows 274a and 274b, so that the overlapping area 276 develops, as this is shown in FIG. 5(B).

Due to the phenomenon of “drifting” of the partial webs 230a and 230b, as described on the basis of FIG. 4, the cutting quality of the cutting machine is influenced negatively, namely both regarding the cross-cut and regarding the longitudinal cut. FIG. 5 shows the errors along the outer longitudinal cutting edge, which occur due to the drift of the partial webs, when separating the tractor edge from the paper web 200. The straightness of this longitudinal cut is influenced since the outer longitudinal blades 220a and 220b already are in a region influenced by the above-described phenomenon of “drifting”. The fact that the partial webs move on top of each other (see FIG. 4(A)) leads to a bulge 282 forming on the longitudinally cut outer edge, as this is shown in FIG. 5(A). The fact that the partial webs move apart in a deceleration, as shown in FIG. 4(B) leads to a step 284 developing on the outer edge.

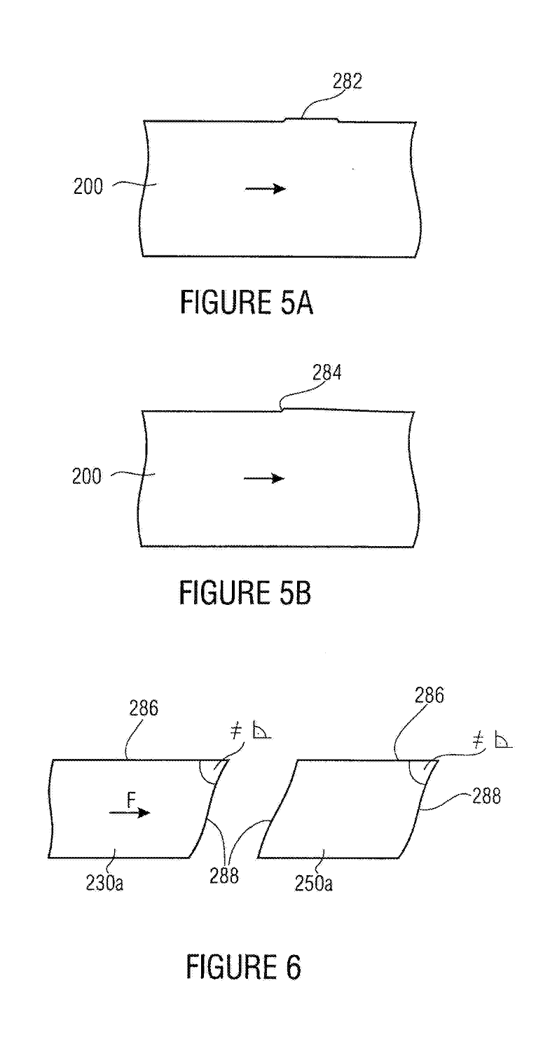

Furthermore, the phenomenon of “drifting” leads to the fact that there is the danger of the cross-cut no longer taking place at a right angle with respect to the paper web edge, as this is shown in FIG. 6, which shows one possible non-rectangular cutting edge of a partial web by a cross-cutter due the drift. The partial web 230a, which is moved to the cross-cutter 240 in conveying direction F, is shown in FIG. 6 in the left area. Due to the drift, the cut by the cross-cutter 240 no longer takes place at a right angle with respect to the paper web outside edge 286, so that cutting edges 288 not at right angles to the individual sheet edge 286 result for the leading end of the paper web 230a as well as for the cut individual sheet 250a.

Hence, there is a need to provide an approach for stabilizing the conveyance of cut webs in a defined location behind a longitudinal cutter. This stabilization is brought about by a device and a method according to embodiments of the invention, as will be described in the following.

Embodiments of the invention relate to a device and a method for conveying a paper web, which ensures stabilization of the transport of the partial webs produced therefrom, with other embodiments of the invention relating to cutting devices in which improvement of the rectangularity of the cross-cut and the straightness of the longitudinal cut by the cutting machine running in start-stop operation is ensured additionally due to the stabilization.

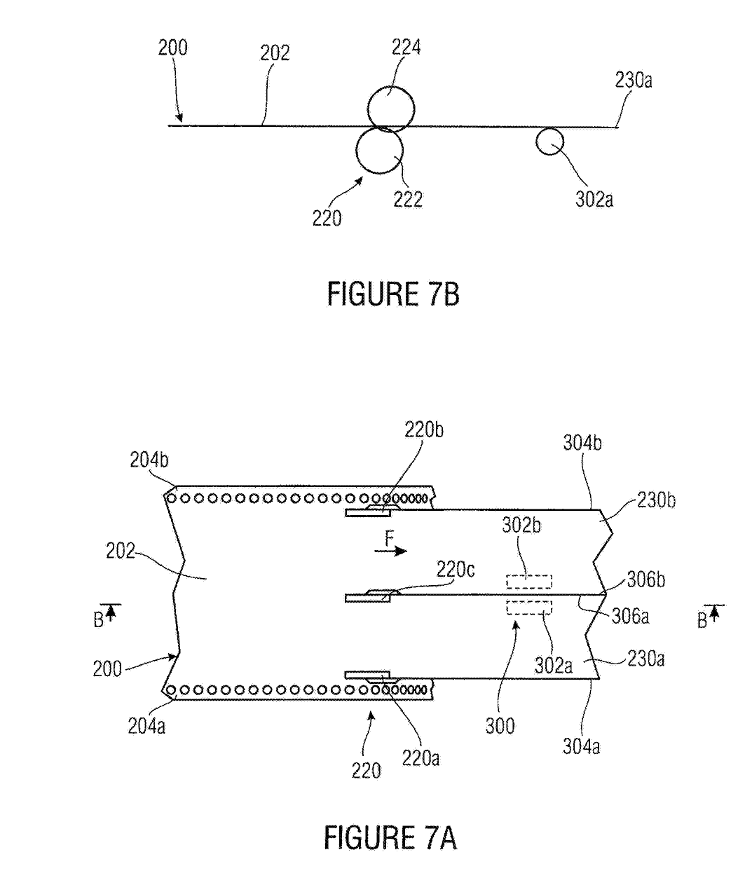

FIG. 7 shows a schematic top-view illustration (FIG. 7(A)) and a schematic side illustration (FIG. 7(B)) of a device for stabilizing the movement of the partial webs, according to an embodiment of the invention, using a roller for supporting each of the partial webs. FIG. 7(B) is an illustration along the line B-B in FIG. 7(B). In FIG. 7 and in the subsequent figures, those elements already having been described on the basis of the previous figures are provided with the same reference numerals, and repeated description of these elements and their functionalities is omitted. FIG. 7 shows an embodiment in which a paper web 200 is advanced in the direction of the conveying direction F, wherein the longitudinal cutter 220 is provided to cut the paper web 200 into the two partial webs 230a and 230b and to cut off the edge areas 204a and 204b. So as to prevent the above-described phenomenon of “drifting”, a support member 300 associated with the two partial webs 230a and 230b such that longitudinal movement in conveying direction of the partial webs 230a and 230b is not hindered, but movement transversely to the conveying direction F is prevented, is arranged downstream of the longitudinal cutter 220 in conveying direction F. In the embodiment shown in FIG. 7, the support member includes a first support element 302a in form of a roller as well as a support element 302b also in form of a roller. Each one of the partial webs 230a and 230b includes an outer edge 304a and 304b as well as an inner edge 306a, 306b. The outer edges 304a and 304b are obtained by removing the edge areas 204a and 204b by the longitudinal cutters 220a and 220b, respectively, and the inner edges 306a and 306b develop by longitudinally cutting the paper web 202 into the two partial webs 230a and 230b by the longitudinal cutter 220c. In the embodiments shown in FIG. 7, the rollers 302a and 302b each are arranged adjacent to the inner edge of the respective partial web 230a and 230b.

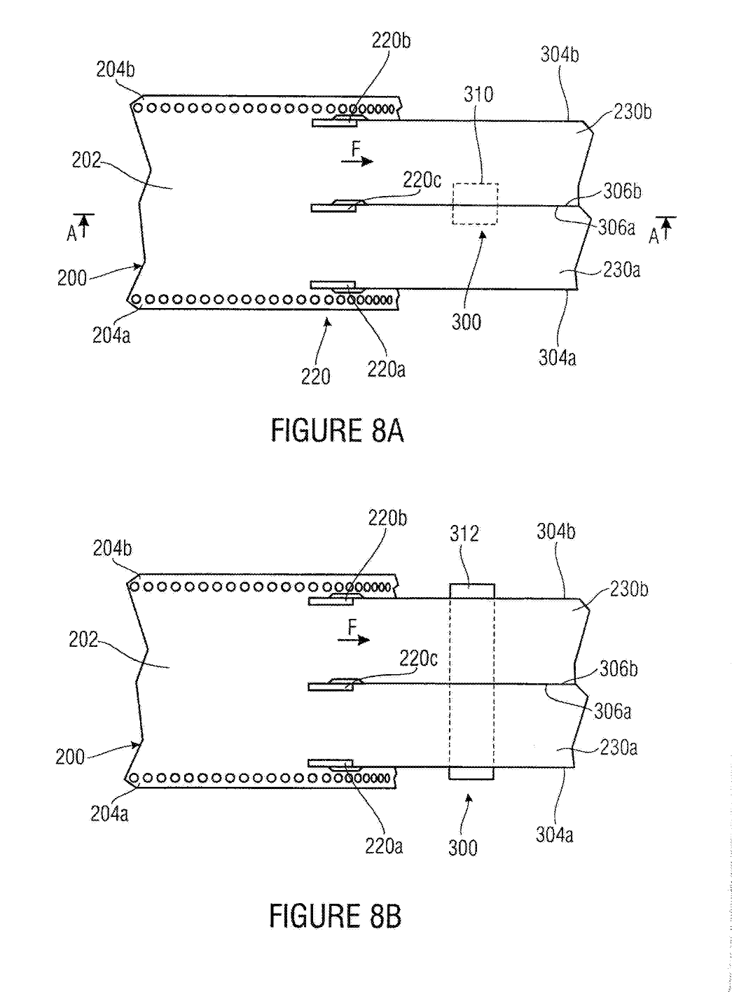

FIGS. 8(A) and (B) show schematic top-view illustrations of a device for stabilizing the movement of cut partial webs according to a second embodiment of the invention. Different from the embodiment described on the basis of FIG. 7, the embodiment described in FIG. 8 uses a common support element in form of a roller 320 acting both on the partial web 230a and on the partial web 230b, as this was described above (FIG. 8(A)). Alternatively, the roller 310 may also extend across the widths of the two partial webs 230a and 230b, and may extend beyond the outer edges 304a and 304b in the embodiment shown. Alternatively, the roller 310 may also be made shorter. The functionality of the roller 310 corresponds to the functionality of the two support elements 302a and 302b, the functionalities of which were described on the basis of FIG. 7.

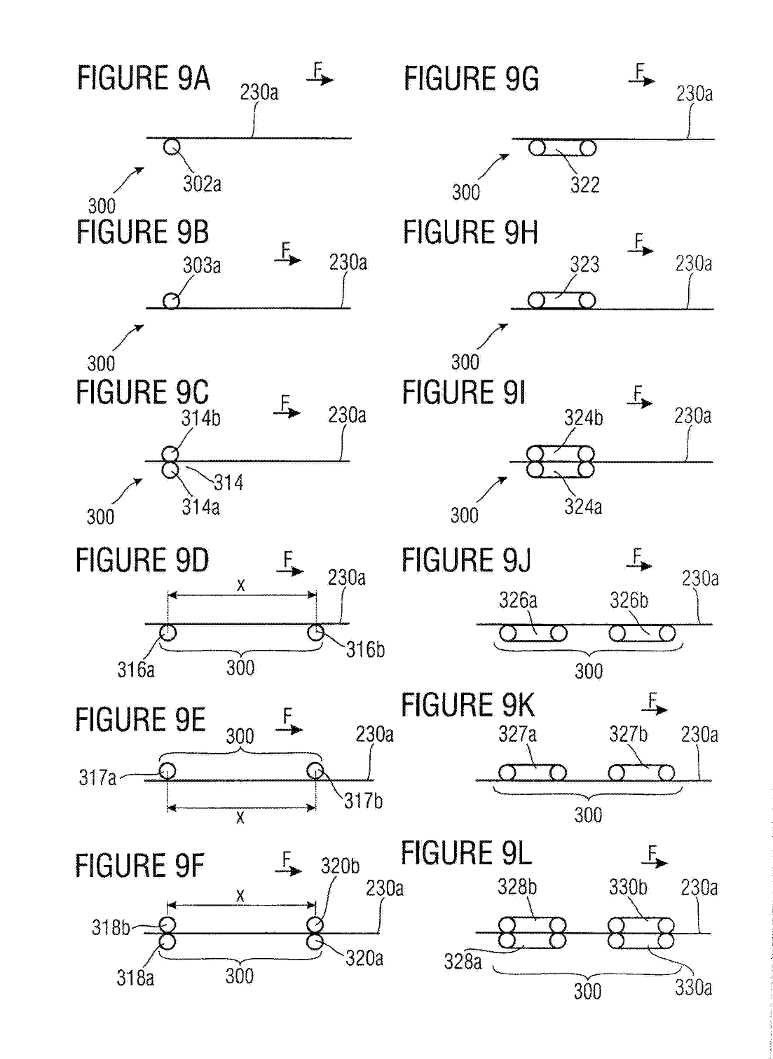

On the basis of FIG. 9, examples of possible configurations of the inventive support elements will be shown in the following. The support elements mentioned on the basis of FIG. 9 may also be employed in the embodiments still to be described in detail in the following. In FIGS. 9(A) to (L), portions of one of the partial webs 230a, 230b each are shown schematically, which webs have the inventive support member 300 associated in various configurations.

On the basis of FIGS. 9(A) to (F), various configurations for the support member, which uses one or more rollers, are shown. FIG. 9(A) shows an example of a configuration, as has been described on the basis of FIG. 7, namely the use of a support roller 302a acting on an underside of the paper web. FIG. 9(B) shows an example of a configuration of a support roller 303a acting on an upper side of the paper web. FIG. 9(C) shows an embodiment similar to FIGS. 9(A) and (B), there being provided, instead of an individual support roller 302a and/or 303a contacting the partial web 230a, a pair of rollers 314 comprising a lower roller 314a as well as an upper roller 314b, wherein the partial web 230 extends between the pair of rollers 314a, 314b. The design of the support member using a roller placed downstream of the longitudinal blade, as described on the basis of FIGS. 9(A) to (C), has a positive effect regarding stabilization of the paper web 230a. The above-described effect of “drifting” is reduced by the arrangement of the support members 300 according to FIGS. 9(A) to (C).

Furthermore, a further support member may be placed after the first conveying element in conveying direction/running direction, so that these two rollers build up a supporting moment with respect to the partial web, so that the partial web can neither rotate nor shift laterally. FIG. 9(D) to (F) show embodiments of such a design. As shown in FIG. 9 (D), the support member 300 includes two rollers 316a and 316b arranged spaced apart from each other and acting on an underside of the paper web. As can be seen, they are arranged spaced apart from each other by distance x along the conveying direction F, whereby the additional, supporting moment is built up. FIG. 9(E) shows a design similar to FIG. 9(D), wherein the support member 300 includes two rollers 317a and 317b arranged spaced apart from each other and acting on an upper side of the paper web. FIG. 9(F) shows a similar configuration, but with two pairs of rollers 318a, 318b and 320a, 320b spaced apart from each other at a distance x in conveying direction F and between which the paper web 230a is conveyed are provided instead of the individual rollers 316a, 316b and/or 317a, 317b.

A similar effect as achieved by the spaced apart rollers according to FIGS. 9(E) to (F) may also be achieved using a belt drive, which may also be formed as a suction belt. FIG. 9(G) to (L) show the formation of the support member 300 as a belt drive, with each belt drive being formed by a pair of spaced-apart rollers around which a belt passes.

FIG. 9(G) shows an arrangement in which a single belt 322 is provided, acting on an underside of the paper web 230a. FIG. 9(H) shows an arrangement similar to FIG. 9(G), wherein a single belt 323 is provided, acting on an upper side of the paper web 230a. Because of the length of the belt in conveying direction F, the additional, supporting moment also is achieved here, as explained on the basis of FIGS. 9(D) to (F). FIG. 9(I) shows a design of the support member 300, wherein it is formed by two belts or a pair of belts 324a, 324b arranged on top of each other, between which the paper web 230a extends.

FIGS. 9(J) to (L) show configurations in which belts each being spaced apart in conveying direction F are provided, wherein FIG. 9(J) shows two belts 326a and 326b spaced apart in conveying direction F and supporting the web 230a. FIG. 9(K) shows two belts 327a and 327b spaced apart in conveying direction F and acting on an upper side of the paper web 230a. FIG. 9(L) shows an arrangement consisting of two spaced-apart pairs of belts 328a, 328b and 330a and 330b.

The widths of the support elements shown in FIG. 9 may be chosen so as to correspond to the widths of the elements as described on the basis of FIGS. 7 and 8. In other words, it may be provided that individual ones of the configurations described on the basis of FIG. 9 are provided for each partial web 230a, 230b (see FIG. 7). The configurations shown in FIG. 9 may also be used as common support elements according to FIG. 8, wherein, depending on the configuration, the width of the rollers/belts is chosen so that these only act thereon in the area of the inner cutting edges 306a, 306b of the partial webs (see FIG. 8(A)) and/or act across a larger, maybe the entire area of the partial web, as this is shown in FIG. 8(B).

In addition, embodiments of the invention may provide that several support elements are arranged in parallel with respect to each other in conveying direction.

Subsequently, embodiments of the invention will be explained on the basis of a cutter and/or a cutting machine, such as are employed in the sheet handling system shown on the basis of FIG. 1, for example.

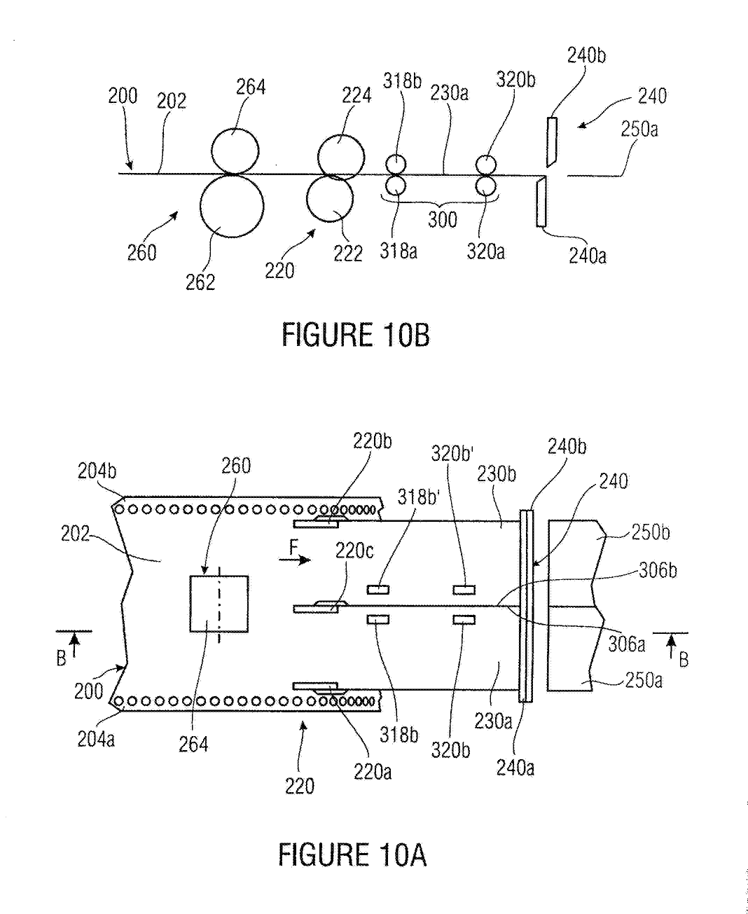

FIG. 10 shows a schematic top-view illustration (FIG. 10(A)) and a schematic side illustration (FIG. 10(B)) of a cutter according to an embodiment of the invention. FIG. 10(B) is an illustration along the line B-B in FIG. 10(A). As can be seen, the cutter described on the basis of FIG. 10 substantially corresponds to the cutter described on the basis of FIG. 3, wherein a support member 300 according to FIG. 9(F) in form of two spaced-apart pairs of rollers is arranged additionally between the longitudinal cutter 220 and the cross cutter 240 of each partial web 230a, 230b. In FIG. 10(A), only the respective upper rollers 318b′ and 320b′ can be seen. The arrangement of the support elements adjacent to the inner edge, which results due to cutting the paper web 202 in the middle, is provided because various formats of the paper web can be processed thereby, without the pairs of rollers having to be displaced in the event of format changes, since each format is arranged in a centered manner with respect to the central longitudinal cutter 220c.

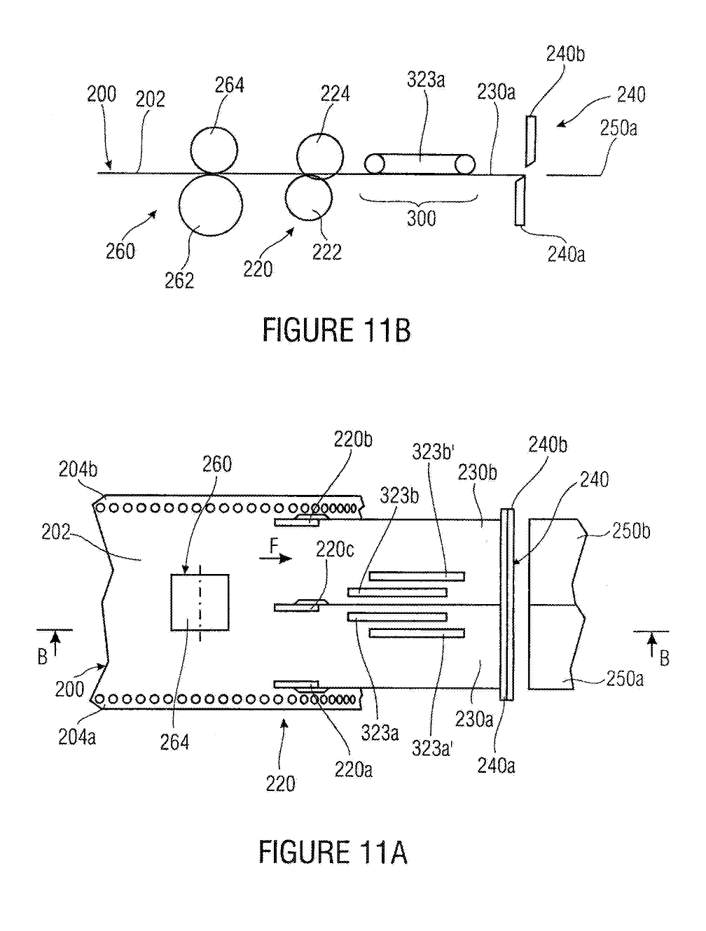

FIG. 11 shows a schematic top-view illustration of a cutter according to an embodiment of the invention, which is similar to the embodiment shown in FIG. 10, but with each partial web 230a, 230b having associated therewith a plurality of support elements 323a, 323a′, 323b, 323b′ arranged in parallel according to FIG. 9(H). As can be seen, the support elements arranged in parallel may be disposed in an offset manner in conveying direction.

The above-described embodiments of the invention teach the use of a support member in various designs, whereby the paper and/or the corresponding partial web, which results from the longitudinal cut of the entire web, is prevented from moving laterally. To this end, the elements according to the embodiments regarding the cutters are to be found between the longitudinal blade 220 and the cross-blade 240. The support elements enable the paper to be advanced in an unimpeded way in running direction F. Laterally, however, the movement is prevented by frictional resistance. The elements may be e.g. belts (see FIGS. 9(G) to (L) passing on top of each other with a certain pressure. Suction belts may also be used. If the mass of the rollers and/or belts is kept sufficiently low, the paper web 200 is capable of also accelerating the same when advanced, without the rollers/belts having to be driven. In the deceleration phase, the mass inertia of the belts/rollers would then lead to tightening of the paper web, which does not represent a disadvantage.

If the mass of the support parts, i.e., the mass of the rollers or belts, exceeds the mass that can be accelerated by movement of the paper web, a drive for also driving the rollers/belts of the support members corresponding to the advance may be provided for avoiding compression of the paper web during the advance thereof.

It may also be provided that the rollers/belts are selectively driven via a switchable drive, depending on the material properties of the paper web. If, for example, a “lightweight” paper web (material having low mass with respect to a dimension in longitudinal direction) is used, the rollers/belts may be driven. If a “heavy” paper web is to be used, the drive may, for example, be disengaged, so that the rollers/belts are accelerated along with the movement of the paper web.

Embodiments of the invention use a roller or a pair of rollers (see FIGS. 9(A) to (C)). If such a configuration is chosen, there is only one roller between the longitudinal blade and the cross-blade, whereby the above-described phenomenon of “drifting” may already be reduced significantly. The paper web may, however, still twist below or above the roller during accelerating or braking, so that a second roller in running direction (see FIGS. 9(E) to (F)) or a corresponding belt drive may be provided, so that a supporting moment related to the web may develop. Hereby, it is achieved that the paper web may neither twist nor shift laterally. With this, it is ensured that the paper web lies correctly under the cross-blade after advancing and is cut off in a straight line. Since the web can no longer drift laterally either, the lateral edge of the sheet also is cut off in a straight line.

It is an advantage of the above-described embodiments, which use low-mass rollers, for example two pairs per partial web, that relatively little space is needed and easy integration in existing constructions is possible. Furthermore, it is not necessary to drive these rollers, so that a drive may be omitted.

The above-described embodiments were explained on the basis of paper webs 200 having perforated strip edges 204a and 204b, wherein a paper web is to be used in a two-up manner each, i.e., is divided into two partial webs. The invention is not limited to such a design, but may generally be applied to situations in which a plurality of partial webs is to be obtained from a paper web for further processing.

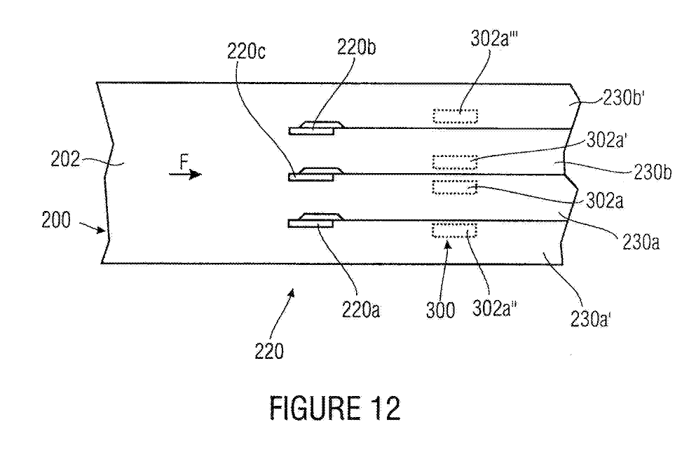

FIG. 12 shows a schematic top view illustration of a device for stabilizing the movement of cut partial webs according to a further embodiment of the invention, wherein the paper web 200 is cut in four partial webs 230a, 230b, 230a′ and 230b′ in FIG. 12. As shown in FIG. 12, a paper web 200 without perforated edges 204a and 204b is used here, driven via a roller drive, for example, as shown at 260 in FIG. 16. In the embodiment shown in FIG. 12, the longitudinal cutter also includes three cutting elements 220a to 220c, wherein the cutting elements 220a and 220b in this embodiment do not serve for cutting off a side edge of the paper web 200, but rather serve to introduce further longitudinal cuts in the paper web 200, so that four adjacently arranged partial webs 230a, 230a′ as well as 230b and 230b′ are obtained from the paper web 200. In this device, there is also provided a support member according to an embodiment of the invention, wherein a configuration similar to FIG. 9(A) is chosen here for each one of the partial webs. The partial web 230a is supported by the roller 302a. The partial web 230b is supported by the roller 302a′. The partial web 230a′ is supported by the roller 302a″, and the partial web 230b′ is supported by the roller 302a′″.

Furthermore, it is to be pointed out that a rotary blade and/or an oscillating blade may also be employed as cutting elements and, for example, as cross-cutters, apart from or instead of a guillotine blade.

Although embodiments using rollers or belts as support elements have been described above, it is to be pointed out that the present invention is not limited thereto. Rather, other elements may be used, which generally are “moveable” (e.g., allow for rotational or translational movement in conveying direction with respect to the web) and thereby substantially block movement of the partial webs transverse to the conveying direction and substantially do not hinder movement of the partial webs in conveying direction. For example, one or more “traveling support fingers” may be used, which are moved along together with the web in the movement of the web in the direction of the blade and act on the web, e.g. in the case of start/stop operation, and are moved back during the standstill of the web.

Embodiments of the cutters have been described above with reference to a system according to FIG. 1. It is to be pointed out that the cutters according to embodiments of the invention may also be used in other systems. For example, a cutter may be positioned upstream of a stacker and receive a preprinted or non-preprinted paper web from a printer or an endless roll and cut the same into individual sheets then supplied to the stacker so as to form stacks of individual sheets. Such a stack may then be retrieved and supplied to further processing. The stack may e.g. be supplied to a printer or a supplement placer of a paper handling system.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Device for cutting a paper web, comprising:
a drive (208; 260) arranged to convey the uncut paper web (200) in a start/stop operation in a conveying direction (F);
a longitudinal cutter (220) arranged behind the drive (208; 206) in conveying direction (F), in order to cut the paper web (200) conveyed in conveying direction (F) into at least a first partial web (230a) and a second partial web (230b);
a support member (300) arranged behind the longitudinal cutter (220) in conveying direction (F) and supporting at least a portion of the first partial web (230a) and at least a portion of the second partial web (230b), wherein the support member (300) is formed to block movement of the first partial web (230a) and the second partial web (230b) in a direction transverse to the conveying direction (F) and not to hinder movement of the first partial web (230a) and the second partial web (230b) in the conveying direction (F); and
a cross-cutter (240) arranged behind the support member (300) in conveying direction (F) so as to cut the partial webs (230a, 230b) into individual sheets (250a, 250b).

2. Device according to claim 1, wherein the support member (300) is moveable.

3. Device according to claim 1 or 2, wherein the support member (300) is arranged to act on the paper web from above and/or from below.

4. Device according to one of claims 1 to 3, wherein the support member (300) comprises a common support element (310, 312) supporting the first partial web (230a) and the second partial web (230b).

5. Device according to one of claims 1 to 3, wherein the support member (300) comprises:
a first support element (302a; 318a, 318b, 320a, 320b; 322; 324a, 324b) arranged behind the longitudinal cutter (220) in conveying direction (F) and supporting the first partial web (230a), wherein the first support element is formed so as to block movement of the first partial web (230a) transverse to the conveying direction (F) and not to hinder movement of the first partial web (230a) in conveying direction (F); and
a second support element (302b; 318b′, 320b′; 322a′; 324b′) arranged behind the longitudinal cutter (220) in conveying direction (F) and supporting the second partial web (230b), wherein the second support element is formed so as to block movement of the second partial web (230b) transverse to the conveying direction (F) and not to hinder movement of the second partial web (230b) in conveying direction (F).

6. Device according to claim 5, wherein one or more of the partial webs have associated therewith a plurality of support elements arranged in parallel transversely to the conveying direction.

7. Device according to one of claims 1 to 6, wherein the first and second partial webs (230a, 230b) each comprise a first edge (304a, 304b) corresponding to the edge of the uncut paper web (200) and a second edge (306a, 306b) caused by longitudinally cutting the paper web (200), wherein the second edges (306a, 306b) of the first partial web (230a) and of the second partial web (230b) are adjacent, and wherein the support member (300) is arranged adjacent to the second edges (306a, 306b) of the first and second partial webs (230a, 230b).

8. Device according to one of claims 1 to 7, wherein the support member (300) is formed so as to prevent the transverse movement of the partial webs (230a, 230b) by way of frictional grip therewith.

9. Device according to one of claims 1 to 8, wherein the support member (300) includes at least one of the following elements:
a single roller (302a, 302b; 310; 312) supporting the partial webs (230a, 230b);
a single pair of rollers (314a, 314b) between which the partial webs (230a, 230b) are arranged;
at least two rollers (316a, 316b) spaced apart in conveying direction (F) and supporting the partial webs (230a, 230b);
at least two pairs of rollers (318a, 318b; 320a, 320b; 318b′; 320b′) spaced apart in conveying direction (F), between which the partial webs (230a, 230b) are arranged;
a single belt (322) supporting the partial webs (230a, 230b);
a single pair of belts (324a, 324b; 324b′) between which the partial webs are arranged;
at least two belts (326, 326b) spaced apart in conveying direction and supporting the partial webs (230a, 230b); or
at least two pairs of belts (328a, 328b, 330a, 330b) spaced apart in conveying direction, between which the partial webs (230a, 230b) are arranged.

10. Device according to claim 9, wherein the support member is driven.

11. Device according to claim 9, wherein the support member is not driven, wherein the mass of the support member is chosen such that the paper web (200) also accelerates same along during movement.

12. Device according to one of claims 1 to 11, wherein the drive includes a tractor drive (208) or a roller drive (260).

13. Device according to one of claims 1 to 12, wherein the cross-cutter (240) comprises a guillotine blade (240b) with or without a counter-blade (240a).

14. Device according to one of claims 1 to 12, wherein the cross-cutter (240) comprises a rotary blade or an oscillating blade.

15. Paper handling system (100), comprising
an input channel for receiving a paper web (108, 110, 112, 200);
a device according to one of claims 1 to 14 for producing a parallel stream of individual sheets from the paper web; and
a processing channel for processing the individual sheets.

16. Method of cutting a paper web, comprising:
driving the uncut paper web (200) in a start/stop operation in a conveying direction (F);
longitudinally cutting the paper web (200) conveyed in conveying direction (F) into at least a first partial web (230a) and a second partial web (230b);
supporting at least a portion of the first partial web (230a) and at least a portion of the second partial web (230b) such that movement of the first partial web (230a) and of the second partial web (230b) in a direction transverse to the conveying direction (F) is blocked and that movement of the first partial web (230a) and of the second partial web (230b) in the conveying direction (F) is not hindered; and
cross-cutting the partial webs (230a, 230b) into individual sheets (250a, 250b).

17. Method according to claim 16, wherein the support member (300) is arranged so as to act on the paper web from above and/or from below.

18. Method according to claim 16 or 17, wherein supporting comprises commonly supporting the first partial web (230a) and the second partial web (230b).

19. Method according to claim 16 or 17, wherein supporting comprises separately supporting the first partial web (230a) and the second partial web (230b).

20. Method according to one of claims 16 to 18, wherein the first and second partial web (230a, 230b) each comprise a first edge (304a, 304b) corresponding to the edge of the uncut paper web (200) and a second edge (306a, 306b) caused by longitudinally cutting the paper web (200), wherein the second edges (306a, 306b) of the first partial web (230a) and of the second partial web (230b) are adjacent, and wherein the first and second partial web (230a, 230b) support adjacent to the second edges (302a, 302b).

21. Method according to one of claims 16 to 19, wherein supporting uses at least one of the following support members:
a single roller (302a, 302b; 310; 312) supporting the partial webs (230a, 230b);
a single pair of rollers (314a, 314b) between which the partial webs (230a, 230b) are arranged;
at least two rollers (316a, 316b) spaced apart in conveying direction (F) and supporting the partial webs (230a, 230b);
at least two pairs of rollers (318a, 318b; 320a, 320b; 318b′; 320b′) spaced apart in conveying direction (F), between which the partial webs (230a, 230b) are arranged;
a single belt (322) supporting the partial webs (230a, 230b);
a single pair of belts (324a, 324b; 324b′) between which the partial webs are arranged;
at least two belts (326, 326b) spaced apart in conveying direction and supporting the partial webs (230a, 230b); or
at least two pairs of belts (328a, 328b, 330a, 330b) spaced apart in conveying direction, between which the partial webs (230a, 230b) are arranged.

22. Method according to claim 16, wherein the support member is driven.

23. Method according to claim 16, wherein the support member is not driven, wherein the mass of the support member is chosen such that the paper web (200) also accelerates it along during movement.
